(19) United States
(12) Patent Application Publication
(10) Pub. No.: US 2002/0140575 A1
(43) Pub. Date: Oct. 3, 2002

(54) System for supplying information on traffic on public thoroughfares

(76) Inventors: Carlos Henrique Levy, Rio de Janeiro (BR); Carlos Augusto Teixeira Mendes, Rio de Janeiro (BR)

Correspondence Address: Beveridge, DeGrandi, Weilacher & Young, Suite 800, 1850 M Street, N.W., Washington, DC, 20036, US

(21) Appl. No.: 09/780,614

(22) Filed: Feb. 12, 2001

(51) Int. Cl. G08G 1/09

(52) U.S. Cl. 340/905; 340/933; 701/117

(57) ABSTRACT

The present invention describes a system for supplying traffic information on public thoroughfares, comprising a collection device (1), which contains sensors to collect data about the traffic on several traffic thoroughfares, the collection device being in communication with a data analyzer (2). This analyzer (2) receives the data referring to the traffic conditions on the traffic thoroughfares from the collection devices (1) and compares it with other data received before and stored in the analyzer's memory. This comparison is made by verifying if any of the received data is different from that stored. If the existence of different data is confirmed, the analyzer then stores it in the analyzer's memory (thus updating its memory data), and sends it to a transmission device (3), so that the latter can send the data, via radio waves, to a receiver (4) located in users vehicles (if the data is the same as that stored, it is discarded). In this way, each receiver (4) located in the user's vehicles only receives data referring to alterations in the traffic on the public thoroughfares. The receiver (4) comprises a data receiving and decoding device (21) to receive and decode data received, via radio waves, from the transmission device (3); a control device (23) to receive the data from the receiving and decoding device (21), and further being connected to a memory of the receiver (24), a control panel (25), and a voice-generating device (26). This control device (23), upon receiving the data from the receiving and decoding device (21), stores this data containing information on the traffic, in the memory of the receiver (24) and, in addition, selects from the data that which should be automatically sent to the voice-generating device (26) to be made available to the user. In addition, when the user wishes to obtain traffic information that has not been automatically made available by the receiver (4), he only has to select the traffic thoroughfare about which he wishes to obtain information, on the control panel (25), so that the control device (23) can retrieve the respective information from the memory of the receiver (24) and make it available to the user by means of the voice-generating device (26).

### FIELD OF THE INVENTION

The present invention relates to a system that supplies a driver on the road with on-line information of the traffic conditions along a city's public thoroughfares. The driver will receive the information by means of a small-size equipment, called receiver, which is apt to inform the data to a user, via voice technology.

### DESCRIPTION OF THE STATE OF THE ART

Several known systems from the prior art provide information services to drivers regarding the traffic conditions.

The U.S. Pat. No. 4,792,803 describes a system for supplying traffic information to drivers, wherein the information are obtained by means of sensors spread throughout the city, sent to an information analyzer and transmitter, and subsequently transmitted by radio waves to receivers located in the vehicles fitted with the system. Each receiver is previously adapted to receive information only from a certain number of traffic areas or thoroughfares selected by the user. The receiver has a panel including a plurality of buttons, each one corresponding to a particular area pre-selected by the driver.

In operation, when the driver wishes to know the conditions of a certain street registered in his receiver, he presses a button referring to the desired street, and the receiver supplies the information about the traffic condition in that street via voice technology. In case a driver wishes to know the traffic conditions in a second street, he presses another button on the panel referring to that street, and then, listen the desired information.

The system of this US patent has, however, a great drawback for the drivers, which results from the need to actuate the various buttons on the panel repeatedly, while he is driving, in order to get information about possible alterations in the traffic. In this way, in order to find out which streets have undergone alterations in traffic conditions, the drivers need to be concerned with periodically actuating the buttons on the panel, which causes discomfort and often diverts the driver's attention, which may cause an accident.

The U.S. Pat. No. 5,835,026, on the other hand, describes a system for supplying information relating to traffic, wherein the information are given by means of a standard display on a “pager” apparatus, without making any use of voice technology. In this system, when the user receives some traffic information, he has to divert his attention from the traffic to read the information in the display, which is quite dangerous and may cause accidents. It should also be noted that the information sent to the users are limited to the areas that are registered in the data bank and associated to each user, that is to say, the driver will only have access to the information referring to the areas which he has previously selected. In the event that a user needs information about a public thoroughfare that is not registered in his route bank, even if the system has such information, the driver cannot obtain it.

In view of these problems and drawbacks presented by the prior art, the objective of the present invention is to provide means that automatically informs the user of any traffic alteration in a particular area of interest, by using voice technology.

It is also an objective of the present invention to provide means by which a user can make a selection of thoroughfares about which he wishes to receive information on the traffic automatically, without excluding the option of consultation of other areas which are not in the selection but are registered in the system.

These objectives have been achieved by means of a system for supplying traffic information that comprises a data-collecting device, a data-transmitting device and a receiver.

The data-collecting device includes sensors spread along the city's thoroughfares, which pick up data relating to the speeds and the number of vehicles passing along the public thoroughfares in question. This device sends the data to a data-transmitting device that, in turn, sends these information to each receiver located in the user's vehicles, via radio waves.

Each receiver has a data receiving and decoding device to receive and decode the updated data received from the data-transmitting device, and then make them available to a control device that, in turn, stores the updated data in a receiver memory. This control device, upon receiving this data, is adapted to identify the data that is different from that stored in the memory and referring to a range of thoroughfares, previously selected by the user, and to send this data automatically to a device responding to the user, which informs the latter by means of voice technology.

In addition, these receivers include a command device to receive commands from the user and to send signals generated by the use of the command device to the control device, so that the latter can retrieve from the receiver's memory the data referring to the information required by the user and send it to the device responding to the user.

In a preferable embodiment of the present invention, an analyzer located outside the users' vehicles is connected to the transmission device for the purpose of intercepting all the data received from the collection device, before it is sent to the receivers in the users' vehicles. Basically, the analyzer makes a pre-selection of the data containing information about the traffic, which will be send to the receivers. In order to effect this pre-selection, the analyzer has a memory, wherein the data coming from the collection device are stored, so that, when the analyzer receives a new data from the collection device, it compares this with the data already stored in the analyzer's memory and, if it is different, the analyzer stores the new data in its memory (so as to update the data contained therein) and send it to the transmission device. This transmission device sends this new data, via radio waves, to the receivers in the users' vehicles. On the other hand, if the new data is the same as the data already stored in the analyzer's memory, it is discarded by the analyzer.

This embodiment enables reduction in the number of transmissions effected by the transmitter and, consequently, in the costs of running the system.

### BRIEF DESCRIPTION OF THE DRAWING

FIG. 1 shows a block diagram of an embodiment of the system of the present invention;

FIG. 2 shows a block diagram of an embodiment of the receiver of the system of the present invention;

FIG. 3 shows a diagram of an embodiment of the receiver panel of the system of the present invention.

### DETAILED DESCRIPTION OF THE INVENTION

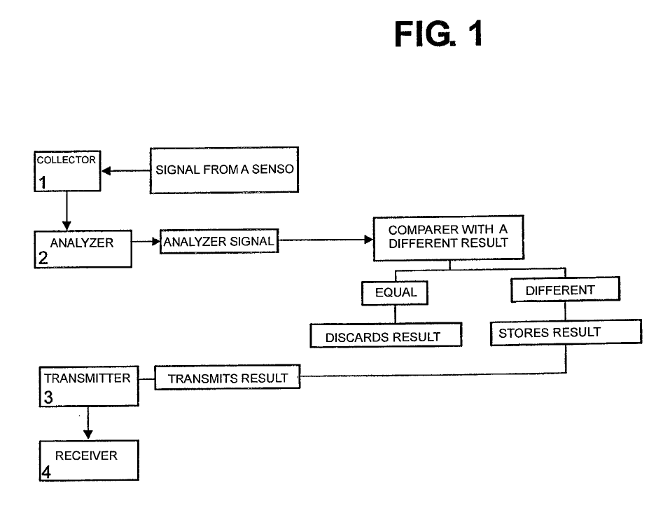

FIG. 1 shows a block diagram illustrating the functioning of the embodiment of the system to receive information about traffic conditions of the city's public thoroughfares. This system is composed of four main components, namely: a collection device 1, an analyzer 2, a transmission device 3, and a receiver 4.

The collection device 1 is responsible for picking up basic information on the traffic and making them available to the analyzer 2. The process of picking up these information may be manual or, preferably, automatic. In this embodiment, the automatic mode is employed, in which the collection device 1 is composed of a network of sensors. The said sensors, which are installed in the public thoroughfares of interest, pick up the data and send it to collection device 1, which in turn, makes it available to the analyzer 2.

Each sensor only informs the collection device 1 of the speed and the number of vehicles that pass over the said sensor.

The analyzer 2 receives the data from the collection device 1 and assesses the traffic situation based on these data. Upon receiving the information about a particular public thoroughfare, the analyzer compares it with the information already stored in the analyzer's memory, and, if it is different, the analyzer stores it in its memory (so as to update it) and sends it to the transmission device 3. In this way, the analyzer 2 always provides updated information.

The transmission device 3 is responsible for sending information on the traffic situation in all districts, streets and reference points to all the receivers that are located at several points of the city. Transmission device 3, in this embodiment, makes use of “page” technology (transmission by radio waves) to send the information about the traffic to each receiver.

The receiver 4, in turn, stores in its memory the traffic information of all streets, districts and reference points, sent by the transmission device 3, and informs, by means of voice, the traffic situation in a particular area of the city selected by the user. In another embodiment, this receiver could also supply the information written on a display, together with voice technology or any other form of response to the user.

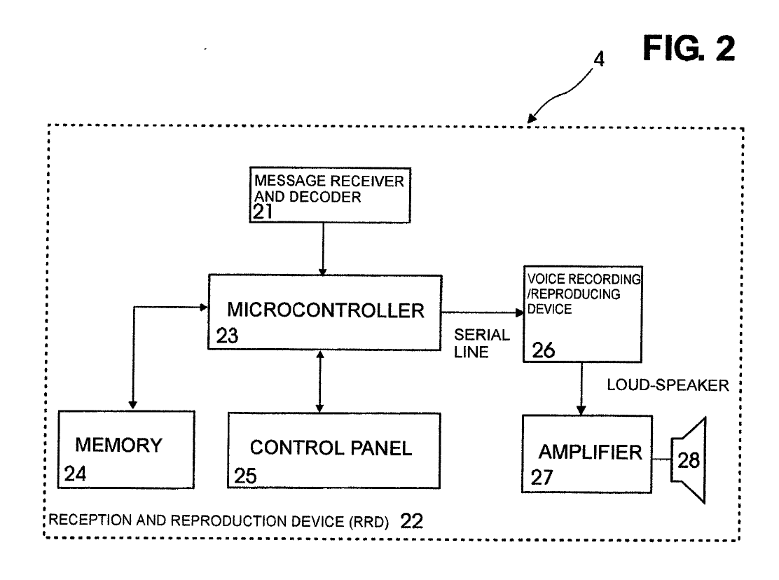

FIG. 2 presents a block diagram of an embodiment of the receiver 4 used in the system of the present invention.

The receiver 4 of this embodiment includes, in the first place, a message receiver and decoder 21, which receives and decodes data transmitted from the transmission device 3. The decoded data are then transmitted by a “semi-duplex” interface RS232 to a reception and reproduction device (DRR) 22, also included in receiver 4.

The reception and reproduction device (DRR) 22 receives the data transmitted serially from the receiver and decoder 21 and, controlled by a microcontroller 23, stores it in the receiver's memory 24. The microcontroller 23 maintains the register referring to the last streets and reference points selected by the user. When the DRR 22 receives the data, the microcontroller 23 identifies the data that are both different from that previously stored and referring to the last streets and reference points selected, and automatically actuates the voice recording and reproducing device 26, making this data available to the user. The voice recording and reproducing device 26 produces sound signals containing the received data relating to the changes in the traffic. These sound signals are, in turn, sent, by means of amplifier 27, to a loud-speaker 28, to be reproduced in a form that is audible and intelligible to the user. The user of the system of the present invention can also select other information (from a place different from those last selected), stored in the receiver memory 24, by means of control panel 25, which will be explained later. In this case, the information is then retrieved from the receiver memory 24 by the microcontroller 23, which actuates the voice recording and reproducing device 26, which, in turn, actuates the loud-speaker 28 by means of an amplifier 27.

The present invention is not limited to the use of voice recording and reproducing device 26, to produce a sound signal in response to the user. It can also be used in other embodiments, for example, as voice synthesizers.

Periodically, there is a retransmission of the complete state of the all data, for the purpose of updating the receivers that by chance are out-of-date.

This outdating may occur, for instance, if the vehicle having the receiver 4 remains without battery or else is in a place that cannot be reached by the radio waves of the present system.

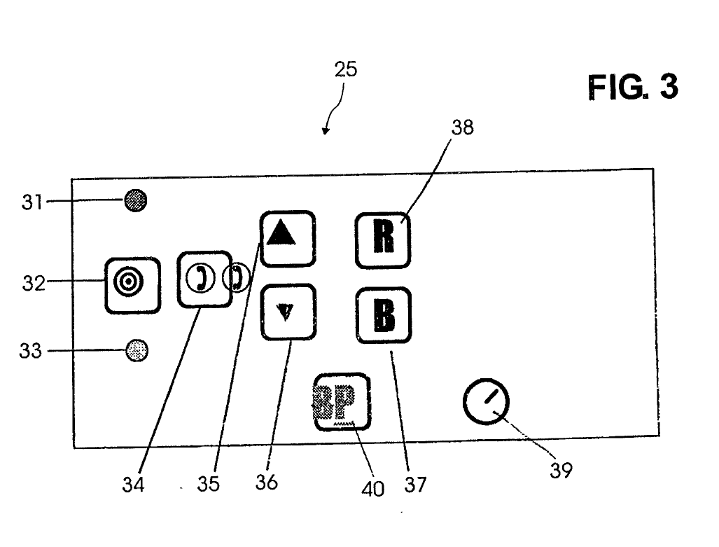

FIG. 3 shows the control panel 25 of the receiver 4 of the system of the present invention. The function of each element indicated in FIG. 3 is described in Table 1, below.

| | |
|---|---|
| 31 - ON/OFF led | It indicates whether the DRR is on |
| | (light on) or off (light off). |
| 32 - ON/OFF button | It is used to turn the DRR on and off |
| 33 - FAC led | When lit, it indicates that the DRR is |
| (out of the covering area) | outside of the covering area. |
| 34 - TRAFFIC level button | It is used to obtain sound information |
| | from the traffic level of the selected |
| | street. |
| 35 - ADVANCE button | It is used in conjunction with the |
| | buttons of REFERENCE POINTS, |
| | DISTRICTS, STREETS and TRAFFIC, |
| | to advance in the list of reference |
| | points, districts, streets of the same |
| | district, and the last selected streets. |
| 36 - BACKSET button | It is used in conjunction with the |
| | buttons of REFERENCE POINT, |
| | DISTRICTS, STREETS and TRAFFIC |
| | to backtrack in the list of the reference |
| | points, districts, streets of the same |
| | district and the last selected streets. |
| 37 - DISCRICT selection button | It is used in conjunction with the |
| | ADVANCE and BACKSET buttons to |
| | select a district. |
| 38 - STREET selection button | It is used in conjunction with the |
| | ADVANCE and BACKSET buttons to |
| | select a street of the selected district. |
| 39 - VOLUME button | It is used to adjust the volume of the |
| | loud-speaker. |
| 40 - REFERENCE POINT | It is used in conjunction with the |
| button | ADVANCE and BACKSET buttons to |
| | select a reference point in the city. |

Operation of the Receiver 4

When the feed voltage is applied to the receiver 4, the local memory 24 assumes an initial state in which all the stored traffic information or upon request from the user is invalid. As the valid messages from the streets, districts and reference points collected are received by the message receiver (21), these messages are stored in the receiver memory 24. The user, in turn, begins to make his selection of the streets, districts and reference points about which ones he wishes to obtain traffic information, by operating the receiver 4, as follows:

1) to Select a District:

The DRR 22 maintains, in the receiver memory 24, a list in alphabetic order of the districts where sensors have been installed. By actuating the DISTRICT button 37, the loud-speaker 28 announces the name of the first district on the above list. The process of choosing a district is started by utilizing the ADVANCE button 35 and the BACKSET button 36, which advance or recede in the list of districts. With each touch, the DRR 22 reproduces, in the loud-speaker, the sound indication of the selected district.

2) To Select a Street:

The DRR 22 maintains, in memory 24, for each district, a list in alphabetic order of the streets where sensors have been installed. By actuating the STREET button 38, the first street of this list is announced by the loud-speaker 28. Again, the selection process is started by actuating the ADVANCE button 35 and the BACKSET button 36, as in the choice of districts mentioned above. At each touch, the DRR 22 reproduces, via the loud-speaker 28, the sound indication of the selected street. In order to confirm the selection of the street, the user should actuate the TRAFFIC button 34. This causes the loud-speaker to announce the traffic level corresponding to the selected street and the system to include it in the LRU (last recently used) list of the last selected places.

3) To Select a Reference Point:

The DRR 22 maintains, in the receiver memory 24, a list in alphabetic order of reference points in the city. By actuating the REFERENCE POINT button 40, the first reference point on the list above is announced, via the loud-speaker 28, and the process of choosing another reference point is started by using the same procedure used for the choice of district or street.

On the basis of the selection made by the user, the microcontroller 23 begins to select and transmit via the loud-speaker 28 all the new information received by the receiver 4, which refers to the last streets and reference points selected by the driver. In this way, the driver will always be automatically informed when any alteration in the traffic occurs in one of the streets selected. However, if the user wants to make a new selection of street or reference points, he only has to repeat the processes for selecting districts, streets and reference points described above.

In addition, if the driver wants to listen once more the traffic conditions of a few street or reference points previously selected by him, he only has to actuate TRAFFIC button 34 and then ADVANCE button 35 or BACKSET button 36, and the receiver 4 will provide the information. These information, as mentioned before, remains stored in the receiver memory 24 in an LRU (last recently used) list with the last selected places (streets or reference points). At each touch, the DRR 22 advances or recedes in this list, reproducing, via the loud-speaker 28, the sound indication of the traffic level in the selected place.

As shown in Table 1, control panel 25 further includes a VOLUME button 39, which allows the driver to adjust the volume of the loud-speaker 28, an ON/OFF led 31 to indicate whether the receiver 4 is ON or OFF, and a FAC led 33 to indicate if the apparatus is in a region beyond the coverage.

The present invention is not restricted to the control panel described above. It can be used in other embodiments, other control panels, for instance, those that have voice-recognition devices, known from the state of the art.

Therefore, it should be understood that the system for receiving on-line information about the traffic conditions in the public thoroughfares described above is only one of the embodiments and examples of situations that might occur, the real scope of the object of the invention being defined in the accompanying claims.

1. A system for supplying traffic information in public thoroughfares including a collection device (1) to collect data referring to a plurality of public thoroughfares, the collection device being in communication with a data-transmission device, which transmits the data to at least one receiver (4) and a command device that can be actuated by the user to obtain information from the system; the receiver (4) being characterized by comprising:
at least one control device (23) to receive the data sent by the data-transmission device and store it in at least one receiver memory (24); the control device (23) being adapted to identify the data that is different from that stored in the receiver memory (24) and referring to a plurality of thoroughfares previously selected by a user, upon receiving such data, and to send it automatically to a user response device; and
the signals generated by the use of the command device, being sent to the control device (23), so that the latter can retrieve from the receiver's memory, the data referring to the information required by the user and send it to the user response device.

2. A system according to claim 1, characterized in that the receiver (4) further comprises a data-decoding device to decode the data sent by the data transmission device and then send it to the control device (23).

3. A system according to claim 1, characterized in that the user response device includes a voice-generating device.

4. A system according to claim 3, characterized in that the voice-generating device is a voice-synthesizer.

5. A system according to claim 3, characterized in that the voice-generating device is a voice-recording and reproducing device (26).

6. A system according to any one of claims 1-5, characterized in that the user response device further includes a display to make the information available in visual form.

7. A system according to claim 1, characterized in that said command device includes a range of keys and buttons (32, 34, 35, 36, 37, 38, 41) that can be actuated by the user.

8. A system according to claim 1, characterized in that the command panel includes a device activated by voice recognition.

9. A system according to claim 1, characterized in that it further includes an analyzer (2) connected to the transmission device (3), the analyzer having a memory; the analyzer (2) being adapted to receive data from the collection device (1) and compare this data with that already stored in the analyzer memory, so that, if any of this data is different from that stored, the analyzer (2) stores it in its memory and send it to the transmission device (3); the analyzer being further adapted to discard the data received from the collection device which are equal to the ones stored in the analyzer's memory.
